(19) United States
(12) Patent Application Publication
(10) Pub. No.: US 2021/0122944 A1
(43) Pub. Date: Apr. 29, 2021

(54) EASY TEAR STICKER ASSEMBLY WITH PATTERN LAYER

(71) Applicant: SEAL KING INDUSTRIAL CO., LTD., Taoyuan City (TW)

(72) Inventor: Chia-Lu WU, TAOYUAN CITY (TW)

(21) Appl. No.: 16/662,552

(22) Filed: Oct. 24, 2019

(51) Int. Cl. C09J 7/29; C09J 7/38; B32B 7/12; B32B 3/30; B32B 7/06

(52) U.S. Cl. CPC C09J 7/29; C09J 7/38; B32B 7/12; B32B 2405/00; B32B 7/06; C09J 2203/334; C09J 2203/338; B32B 3/30

(57) ABSTRACT

An easy tear sticker assembly with a pattern layer includes a base and plural easy tear sticker units. Each easy tear sticker unit includes plural easy tear stickers stacked on top of the other and disposed on a setting surface of the base. Particularly, the design of this disclosure provides a spacing between any two adjacent easy tear sticker units, so that when a user tears an easy tear sticker from any easy tear sticker unit, the easy tear sticker on the adjacent easy tear sticker unit will not be affected, so that this disclosure allows users to tear the easy tear sticker with the pattern layer easily and has the advantages of free of degumming and free of any early show of the sticky mark. In addition, the easy tear sticker of this disclosure provides a confidential effect and/or an anti-counterfeiting effect through different forms.

### FIELD OF INVENTION

The present disclosure relates to the field of easy tear stickers, in particular to an easy tear sticker assembly having a pattern layer and an anti-counterfeiting function.

### BACKGROUND OF INVENTION

### Description of the Related Art

Slice-type stickers such as Easy Tear Stickers and Post-it Notes are common adhesive items used in our daily life. For example, the stickers are used for sealing the opening of a portable cup or labeling a document, etc. In general, a commercial slice-type sticker stack is one formed by combining and stacking a plurality of stickers. With reference to FIG. 1 for a perspective view of a conventional slice-type sticker stack, as we all know, a user simply tears a slice-type sticker 11a from a slice-type sticker stack 1a and sticks the slice-type sticker 11a onto an object to be affixed for a one-time use.

To integrate more slice-type stickers into the same stack to facilitate users' free selection and use, related sticker manufacturers usually adopt a cylindrical base to carry several slice-type sticker stacks simultaneously. With reference to FIGS. 2 and 3 for the perspective views of a conventional slice-type sticker stack with a cylindrical base and a conventional slice-type sticker stack with a cylindrical base viewing from different angles respectively, the plurality of slice-type sticker stacks 1a is disposed on a side of the same cylindrical base 2a. It is noteworthy that the sides of any two adjacent slice-type sticker stacks 1a on the cylindrical base 2a abut each other due to the factors and limitations of the manufacturing process. Therefore, when a user tears a slice-type sticker 11a from any slice-type sticker stack 1a as shown in FIG. 3, the slice-type sticker 11a of the adjacent slice-type sticker stack 1a may be torn altogether.

In addition, practical experience indicates that even if the adjacent slice-type sticker 11a is not torn altogether when the user tears a slice-type sticker 11a from any slice-type sticker stack 1a, a portion of the adhesive layer of the adjacent slice-type sticker 11a may be scraped off. As a result, the remaining slice-type stickers 11a may fall off from their slice-type sticker stack 1a. In particular, if the slice-type sticker 11a has the confidential and/or anti-counterfeiting function and the slice-type sticker 11a is torn altogether with the adjacent slice-type sticker 11a, the pattern of the slice-type sticker 11a will be torn open, so that the mark of the pattern may be exposed in advance. As a result, such slice-type sticker 11a no longer has the confidential and/or anti-counterfeiting function.

In view of the aforementioned drawback of the conventional slice-type sticker stack with a cylindrical base, it is necessary to redesign the conventional slice-type sticker stack and provide a new slice-type sticker stack having a cylindrical base with the advantages of easy tear and adhesion, free of degumming, and good confidential (and/or anti-counterfeiting) function.

### SUMMARY OF THE INVENTION

Therefore, it is a primary objective of this disclosure to provide an easy tear sticker assembly with a pattern layer comprising a base and a plurality of easy tear sticker units. According to the design of this disclosure, each of the easy tear sticker units includes a plurality of easy tear stickers stacked on top of the other and disposed on a setting surface of the base. Particularly, the design of this disclosure provides a spacing between any two adjacent easy tear sticker units, so that when a user tears an easy tear sticker from any easy tear sticker unit, the easy tear sticker of the adjacent easy tear sticker unit will not be affected. To put it simply, the special design of the spacing between any two adjacent easy tear sticker units allows users to tear the easy tear sticker with the pattern layer easily and has the advantages of free of degumming and free of any early show of the sticky mark.

The secondary objective of this disclosure is to provide a special design for the structural assembly of each easy tear sticker, so that the easy tear sticker provides a confidential effect and/or an anti-counterfeiting effect through different forms.

To achieve the aforementioned and other objectives, this disclosure discloses a first embodiment (Full Transfer) of an easy tear sticker assembly with a pattern layer comprising: a base, with a setting surface; and a plurality of easy tear sticker units, disposed on the setting surface of the base, and having a space between any two adjacent easy tear sticker units; wherein, each of the easy tear sticker units comprises a plurality of easy tear stickers stacked on top of the other, and each of the easy tear stickers comprises: an underlayer; a pattern layer, covering an inner surface of the underlayer, and having a first pattern and a pattern gap; wherein the first pattern is formed on the inner surface of the underlayer; a fixing colored portion, covering the pattern layer, and comprising a first fixing colored portion covering the first pattern, and a second fixing colored portion filled into the pattern gap; and an adhesive layer, covering the fixing colored portions.

In the easy tear sticker assembly with a pattern layer in accordance with the first embodiment of this disclosure, the base is a cylindrical base a slice-shaped base.

In the easy tear sticker assembly with a pattern layer in accordance with the first embodiment of this disclosure, the underlayer has at least one extension, such that the length of the underlayer is greater than the length of the pattern layer, the fixing colored portion, and the adhesive layer.

In the easy tear sticker assembly with a pattern layer in accordance with the first embodiment of this disclosure, the first pattern is one selected from the group consisting of a text, a letter, a number, a symbol, a figure, and a combination thereof.

In the easy tear sticker assembly with a pattern layer in accordance with the first embodiment of this disclosure, the pattern layer is adhered to the first fixing colored portion of the fixing colored portion with an adhesion force smaller than the adhesion force of the underlayer with the pattern layer, and the pattern layer is adhered to the first fixing colored portion of the fixing colored portion with an adhesion force smaller than the adhesion force of the adhesive layer with the first fixing colored portion of the fixing colored portion, and the underlayer is adhered to the second fixing colored portion of the fixing colored portion with an adhesion force greater than the adhesion force of the adhesive layer with the second fixing colored portion of the fixing colored portion.

In the easy tear sticker assembly with a pattern layer in accordance with the first embodiment of this disclosure, when the easy tear sticker is attached onto a surface of a sealed object and a force is applied to an end of the underlayer to lift the underlayer, then the whole adhesive layer will remain at the surface of the sealed object, and the whole first fixing colored portion covering the first pattern will stick onto the adhesive layer, and the pattern layer and the second fixing colored portion in the pattern gap will be separated together with the underlayer from the surface of the sealed object.

In the easy tear sticker assembly with a pattern layer in accordance with the second embodiment of this disclosure (Semi Transfer), the fixing colored portion is adhered to the underlayer with an adhesion force greater than the adhesion force of the fixing colored portion with the pattern layer, and the adhesive layer is adhered to the fixing colored portion with an adhesion force greater than the adhesion force of the fixing colored portion with the pattern layer of the first fixing colored portion.

In the easy tear sticker assembly with a pattern layer in accordance with the second embodiment of this disclosure, when the easy tear sticker is attached onto a surface of a sealed object and a force is applied to an end of the underlayer to lift the underlayer, the adhesion of the adhesive layer with the sealed object will act on the fixing colored portion, so that the fixing colored portion produces an action force to separate the pattern layer and the underlayer, and a void is formed between the first fixing colored portion of the fixing colored portion and the pattern layer by pulling.

In the easy tear sticker assembly with a pattern layer in accordance with the third embodiment of this disclosure (No Transfer), the adhesive layer is adhered to the fixing colored portion with an adhesion force greater than the adhesion force of the fixing colored portion of the first fixing colored portion with the pattern layer, and the adhesive layer is adhered to the fixing colored portion with an adhesion force smaller than the adhesion force of the fixing colored portion with the underlayer, and the fixing colored portion is adhered to the underlayer with an adhesion force greater than the adhesion force of the first fixing colored portion of the fixing colored portion with the pattern layer.

In the easy tear sticker assembly with a pattern layer in accordance with the third embodiment of this disclosure, when the easy tear sticker is attached onto a surface of a sealed object and a force is applied to an end of the underlayer to lift the underlayer, a gap is produced between the first fixing colored portion of the fixing colored portion and the pattern layer, and the adhesive layer will not remain on the sealed object.

### BRIEF DESCRIPTION OF THE DRAWINGS

FIG. 1 is a perspective view of a conventional slice-type sticker stack;

FIG. 2 is a perspective view of a conventional slice-type sticker stack with a cylindrical base (viewing from an angle);

FIG. 3 is a perspective view of a conventional slice-type sticker stack with a cylindrical base (viewing from another angle);

FIG. 4A is a first perspective view of an easy tear sticker assembly with a pattern layer of this disclosure;

FIG. 4B is a second perspective view of an easy tear sticker assembly with a pattern layer of this disclosure;

FIG. 5 is a cross-sectional view of an easy tear sticker in accordance with a first embodiment of this disclosure;

FIG. 6 is a perspective view of an easy tear sticker and a sealed object of this disclosure;

FIGS. 7A and 7B show a procedure of tearing an easy tear sticker from a sealed object in accordance with the first embodiment of this disclosure;

FIG. 8 is a bottom view of an underlayer of an easy tear sticker in accordance with the first embodiment of this disclosure;

FIG. 9 is a bottom view of an adhesive layer of an easy tear sticker in accordance with the first embodiment of this disclosure;

FIG. 10 is a cross-sectional view of an easy tear sticker in accordance with a second embodiment of this disclosure;

FIG. 11 is a cross-sectional view of an easy tear sticker after use in accordance with the second embodiment of this embodiment;

FIG. 12 is a bottom view of an underlayer of an easy tear sticker in accordance with the second embodiment of this disclosure;

FIG. 13 is a cross-sectional view of an easy tear sticker in accordance with a third embodiment of this disclosure;

FIGS. 14A and 14B show the procedure of tearing an easy tear sticker from a sealed object in accordance with the third embodiment of this disclosure; and

FIG. 15 is a bottom view of an underlayer of an easy tear sticker in accordance with the third embodiment of this disclosure.

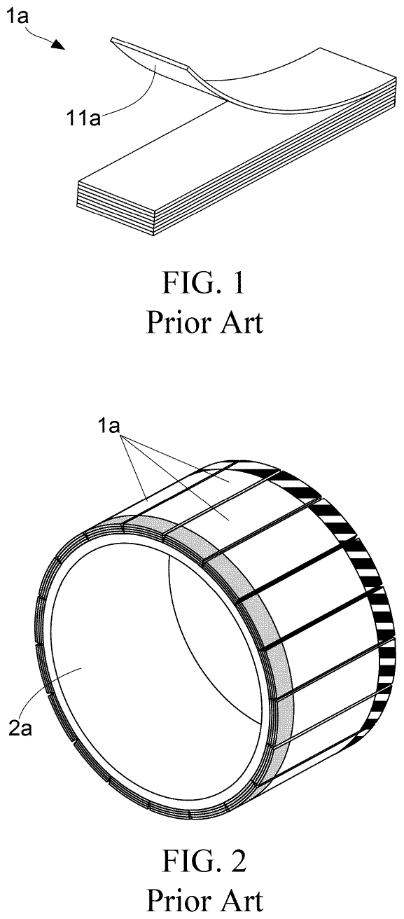

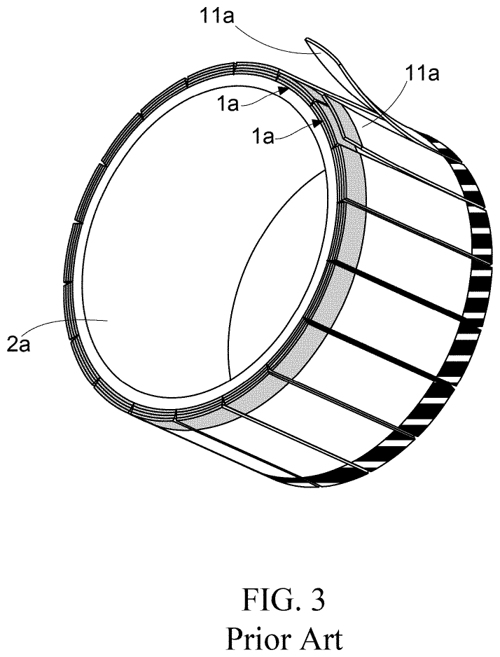

### DESCRIPTION OF THE PREFERRED EMBODIMENTS

The present disclosure will become clearer in light of the following detailed description of an illustrative embodiment of this disclosure described in connection with the drawings, so that people having ordinary skill in the art can implement the present disclosure according to the description of this specification.

### First Embodiment (Full Transfer)

The first embodiment of this disclosure (Full Transfer) is described below. The so-called “full transfer” refers to the adhesive layer of the easy tear sticker that will be transferred onto a sealed object, and the handwriting or pattern at the underlayer of the easy tear sticker will be shown when the confidential easy tear sticker is torn open.

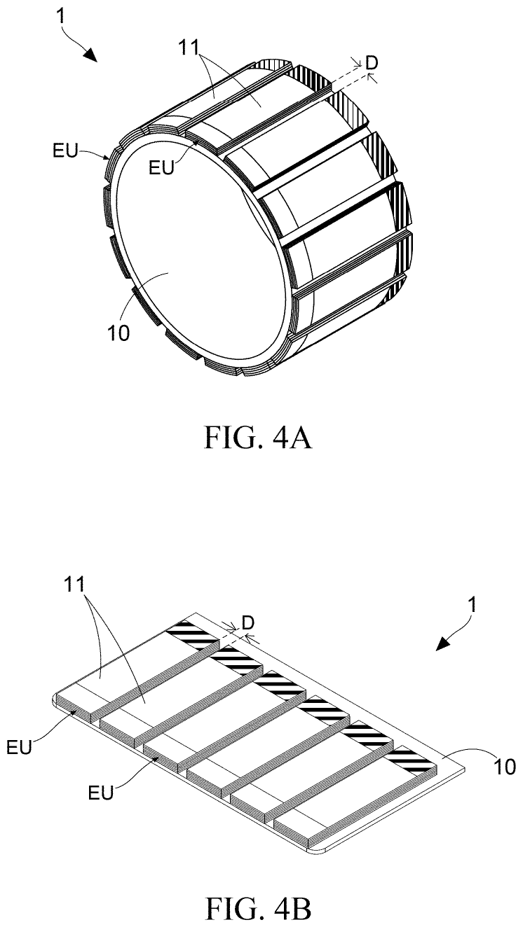

With reference to FIGS. 4A and 4B for the first and second perspective views of an easy tear sticker assembly with a pattern layer 1 in accordance with this disclosure respectively, the easy tear sticker assembly with a pattern layer 1 comprises: a base 10 and a plurality of easy tear sticker units EU, wherein the plurality of easy tear sticker units EU is installed on a setting surface of the base 10. For example, the base 10 as shown in FIG. 4A is a cylindrical base and the setting surface is the annular side of the base 10; on the other hand, the base 10 as shown in FIG. 4B is a slice-shaped base and the setting surface is a surface of the base 10. According to the design of this disclosure, each of the easy tear sticker units EU comprises a plurality of easy tear stickers 11 stacked on top of the other, and a spacing D formed between any two adjacent easy tear sticker units EU. In such design, when a user tears an easy tear sticker 11 from any one of the easy tear sticker units EU, the easy tear stickers 11 of the adjacent easy tear sticker units EU will not be affected. Briefly, the special design of having a spacing D between any two adjacent easy tear sticker units EU allows the easy tear stickers to be torn off easily, and the easy tear sticker assembly with a pattern layer 1 of this disclosure to have the advantages of free of degumming and free of any early show of the sticky mark.

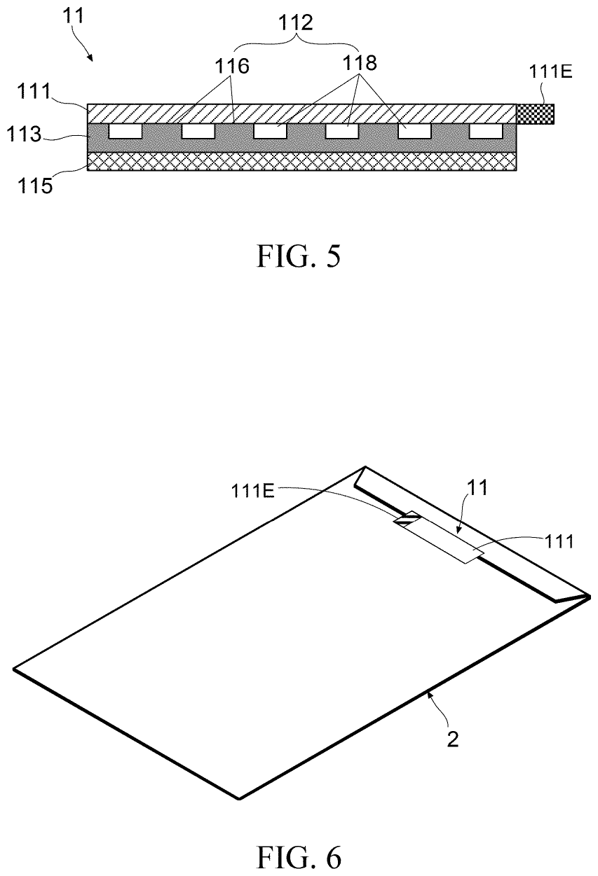

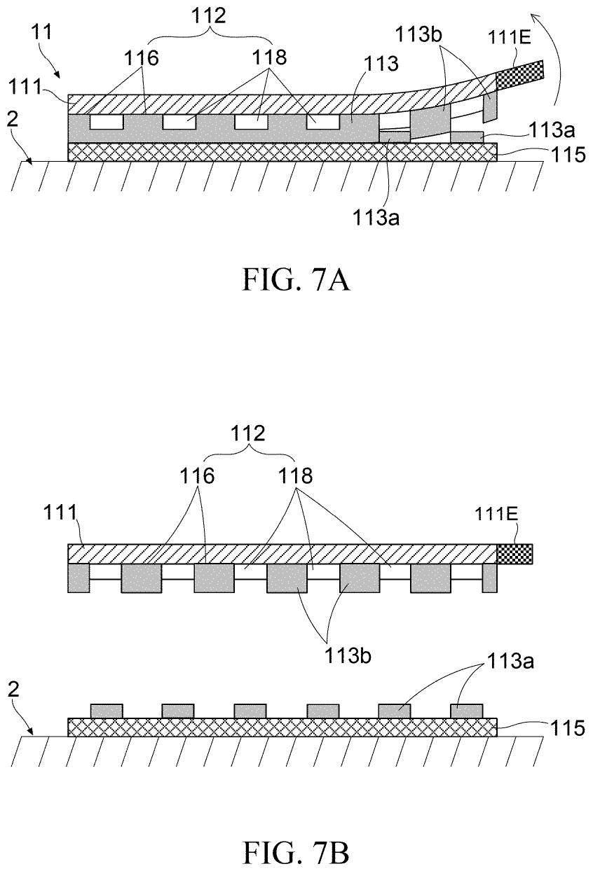

With reference to FIG. 5 for a cross-sectional view of an easy tear sticker of this disclosure, each easy tear sticker 11 in the easy tear sticker unit EU comprises: an underlayer 111, a pattern layer 112, a fixing colored portion 113, and an adhesive layer 115. With reference to FIG. 6 for the perspective view of an easy tear sticker and a sealed object of this disclosure and FIGS. 7A and 7B for the procedure of tearing the easy tear sticker from the sealed object, the pattern layer 112 covers an inner surface of the underlayer 111 and has a first pattern 118 and a pattern gap 116 as shown in FIGS. 5 and 7B. On the other hand, the fixing colored portion 113 is covered on the pattern layer 112 and comprises a first fixing colored portion 113 disposed on the first pattern 118 and covering the pattern layer 112 and a second fixing colored portion 113b filled into the pattern gap 116 of the pattern layer 112. For example, the fixing colored portion 113 is a red pigment layer, and the first pattern 118 is covered by a red pigment (which is the first fixing colored portion 113a) to show a red color. In a practical application, the fixing colored portion 113 may also be a multi-color pigment layer, and this disclosure is not limited to the mono-color pigment layer only.

In addition, the adhesive layer 115 is covered onto the fixing colored portion 113. In the easy tear sticker assembly with a pattern layer 1 in accordance with the first embodiment of this disclosure, it is noteworthy that the pattern layer 112 is adhered to the first fixing colored portion 113a of the fixing colored portion 113 with an adhesion force smaller than the adhesion force of the underlayer 111 with the pattern layer 112, and the pattern layer 112 is adhered to the first fixing colored portion 113a of the fixing colored portion 113 with an adhesion force smaller than the adhesion force of the adhesive layer 115 with the first fixing colored portion 113a of the fixing colored portion 113, and the underlayer 111 is adhered to the second fixing colored portion 113b of the fixing colored portion 113 with an adhesion force greater than the adhesion force of the adhesive layer 115 with the second fixing colored portion 113b of the fixing colored portion 113.

In FIGS. 5 and 6, the underlayer 111 has at least one extension 111E, so that the length of the underlayer 111 is greater than the length of the pattern layer 112, the fixing colored portion 113, and the adhesive layer 115. In FIG. 7A, after one of the easy tear stickers 11 is attached onto a surface of a sealed object 2, the user may selectively hold the extension 111E to apply a force to an end of the underlayer 111 and lift the underlayer 111 in order to complete the procedure of tearing the easy tear sticker 11. In FIG. 7B, after the tearing process of the easy tear sticker 11 is completed, it is found that the whole adhesive layer 115 remains on the surface of the sealed object 2, and the whole first fixing colored portion 113a covering the first pattern 118 sticks onto the adhesive layer 115. The main reason of such result resides on that the special design of the first embodiment of this disclosure lets the pattern layer 112 be adhered to the first fixing colored portion 113a of the fixing colored portion 113 with an adhesion force smaller than the adhesion force of the underlayer 111 with the pattern layer 112, and lets the pattern layer 112 be adhered to the first fixing colored portion 113a of the fixing colored portion 113 with an adhesion force smaller than the adhesion force of the adhesive layer 115 with the first fixing colored portion 113a of the fixing colored portion 113, and lets the underlayer 111 be adhered to the second fixing colored portion 113b of the fixing colored portion 113 with an adhesion force greater than the adhesion force of the adhesive layer 115 with the second fixing colored portion 113b of the fixing colored portion 113. In FIGS. 7A and 7B, after the tearing process of the easy tear sticker 11 is completed, the pattern layer 112 and the second fixing colored portion 113b filled into the pattern gap 116 are separated together with the underlayer 111a from the same surface of the sealed object 2.

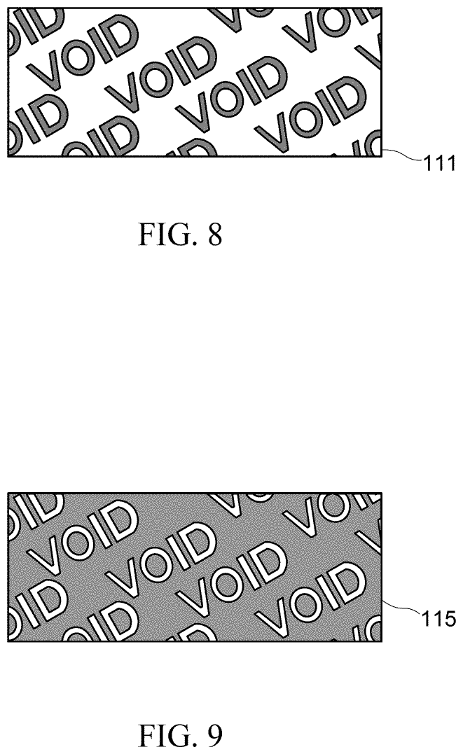

With reference to FIG. 8 for the bottom view of the underlayer, after the tearing process of the easy tear sticker 11 is completed, the pattern layer 112 and the second fixing colored portion 113b filled into the pattern gap 116 will be separated together with the underlayer 111a from the same surface of the sealed object 2. It is noteworthy that the underlayer 111 is a thin plastic sheet, and the first pattern 118 of the pattern layer 112 is shown on an inner surface of the underlayer 111, so that the bottom view of the underlayer 111 looks like FIG. 8.

In FIG. 7B and FIG. 9 that shows the bottom view of the adhesive layer, after the tearing process of the easy tear sticker 11 is completed, the first fixing colored portion 113a originally covered onto the pattern layer 112 will be adhered onto the adhesive layer 115. Now, the bottom view of the adhesive layer 115 looks like FIG. 9. Although the patterns used for the anti-counterfeiting function as shown in FIGS. 8 and 9 are “Void”, yet this word is just used for illustrating the present disclosure only, but not intended to limit the actual form of the pattern. In an application, the pattern (or the first pattern 118) may be a text, a letter, a number, a symbol, a figure, or any combination of the above.

### Second Embodiment (Semi Transfer)

The second embodiment of this disclosure (Semi Transfer) is described below. The so-called “semi transfer” refers to half of the adhesive layer of the easy tear sticker that will be transferred onto a sealed object, and the handwriting or pattern at the underlayer of the easy tear sticker will be shown when the confidential easy tear sticker is torn open.

With reference to FIGS. 4A and 4B for the first and second perspective views of an easy tear sticker assembly with a pattern layer 1 in accordance with this disclosure respectively, the easy tear sticker assembly with a pattern layer 1 of the second embodiment also comprises: a base 10 and a plurality of easy tear sticker units EU, and each of the easy tear sticker units EU comprises a plurality of easy tear stickers 11 stacked on top of the other, and a spacing D between any two adjacent easy tear sticker units EU.

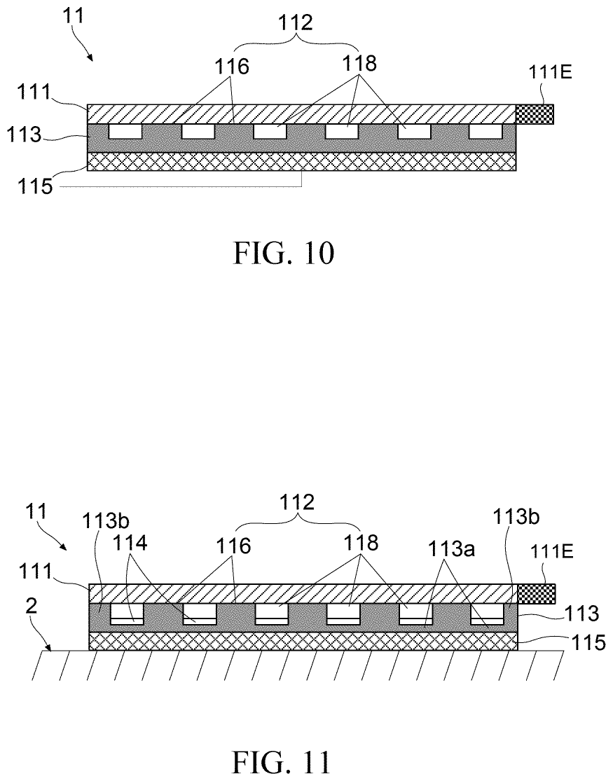

With reference to FIG. 10 for a cross-sectional view of an easy tear sticker in accordance with the second embodiment of this disclosure, and FIG. 11 for a cross-sectional view of the easy tear sticker after use, it is noteworthy that the easy tear sticker 11 of the second embodiment is based on the structure of the first embodiment and appropriate adjustments are made according to the design of this disclosure. The so-called “after use” here refers the easy tear sticker 11 attached onto the surface of a sealed object 2 (as shown in FIG. 6) first, and then torn away from the surface of the sealed object 2. Wherein, FIG. 11 is a cross-sectional view showing that after the easy tear sticker 11 is torn away from the surface of the sealed object 2 first and then attached onto the surface of the sealed object 2.

In FIGS. 10 and 11, the easy tear sticker 11 of the second embodiment comprises: an underlayer 111, a pattern layer 112, a fixing colored portion 113, and an adhesive layer 115, wherein the pattern layer 112 is covered onto an inner surface of the underlayer 111 and has a first pattern 118 and a pattern gap 116. In addition, the fixing colored portion 113 is covered onto the pattern layer 112 and comprises a first fixing colored portion 113a covered onto the first pattern 118 of the pattern layer 112 and a second fixing colored portion 113b filled into the pattern gap 116 of the pattern layer 112.

In the second embodiment, the fixing colored portion 113 is adhered to the underlayer 111 with an adhesion force greater than the adhesion force of the fixing colored portion 113 with the pattern layer 112, and the adhesive layer 115 is adhered to the fixing colored portion 113 with an adhesion force greater than the adhesion force of the first fixing colored portion 113a of the fixing colored portion 113 with the pattern layer 112. In such design, after a piece of the easy tear sticker 11 is attached to a surface of a sealed object 2, a user may apply a force to an end of the underlayer 111 to lift the underlayer 111, and selectively hold the extension 111E of the underlayer 111 to apply a force to the underlayer 111 to lift the underlayer 111, so as to complete the tearing process of the easy tear sticker 11. However, during the process of tearing the easy tear sticker 11, the adhesion force of the adhesive layer 115 with the sealed object 2 will be acted onto the fixing colored portion 113, so that the fixing colored portion 113 produces an action force to separate the pattern layer 112 and the underlayer 111. Now, the adhesion force of the fixing colored portion 113 with the underlayer 111 is greater than the adhesion force of the fixing colored portion 113 with the pattern layer 112, so that a void 114 is formed between the first fixing colored portion 113a of the fixing colored portion 113 and the pattern layer 112 by pulling, and a close contact status is maintained between the first fixing colored portion 113a of the fixing colored portion 113 and the underlayer 111.

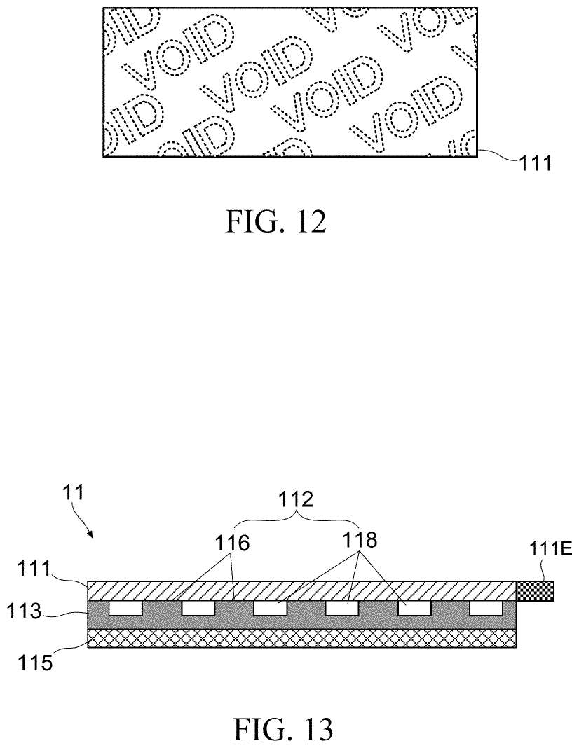

With reference to FIG. 12 for a bottom view of a surface of an underlayer 111 of the easy tear sticker as well as FIG. 11, the first pattern 118 of the pattern layer 112 is shown by the void 114. Therefore, the bottom view of the underlayer 11 shows the text “Void” or “Already Opened” (shown by the void 114) has the confidential effect. In this case, even if the torn-off easy tear sticker 11 is attached back onto the sealed object 2 (as shown in FIG. 11), it will be difficult to cover up the fact that the easy tear sticker 11 has been torn.

### Third Embodiment (No Transfer)

The third embodiment of this disclosure (No Transfer) is described below. The so-called “no transfer” refers to the adhesive layer of the easy tear sticker that will not be transferred onto a sealed object, and the handwriting or pattern at the underlayer of the easy tear sticker will be shown when the confidential easy tear sticker is torn open

With reference to FIGS. 4A and 4B for the first and second perspective view views of an easy tear sticker assembly with a pattern layer 1 in accordance with this disclosure respectively, the easy tear sticker assembly with a pattern layer 1 of the third embodiment also comprises a base 10 and a plurality of easy tear sticker units EU, wherein each of the easy tear sticker units EU comprises a plurality of easy tear stickers 11 stacked on top of the other, and a spacing D formed between any two adjacent easy tear sticker units EU.

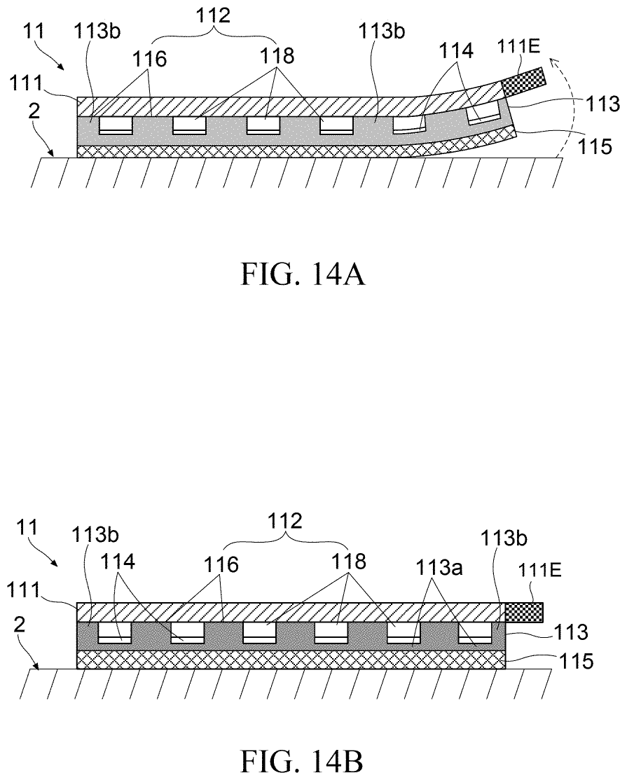

With reference to FIG. 13 for a cross-sectional view of an easy tear sticker in accordance with the third embodiment of this disclosure, and FIGS. 14A and 14B for the procedure of tearing the easy tear sticker from the sealed object, it is noteworthy that the easy tear sticker 11 of the third embodiment is based on the structure of the first embodiment and appropriate adjustments are made according to the design of this disclosure.

In FIGS. 13, 14A and 14B, the easy tear sticker 11 of the third embodiment comprises: an underlayer 111, a pattern layer 112, a fixing colored portion 113, and an adhesive layer 115, wherein the pattern layer 112 is covered onto an inner surface of the underlayer 111 and has a first pattern 118 and a pattern gap 116. In addition, the fixing colored portion 113 is covered onto the pattern layer 112 and comprises a first fixing colored portion 113a covered onto the first pattern 118 of the pattern layer 112 and a second fixing colored portion 113b filled into the pattern gap 116 of the pattern layer 112. In the third embodiment, the adhesive layer 115 is adhered to the fixing colored portion 113 with an adhesion force greater than the adhesion force of the first fixing colored portion 113a of the fixing colored portion 113 with the pattern layer 112, and the adhesive layer 115 is adhered to the fixing colored portion 113 with an adhesion force smaller than the adhesion force of the fixing colored portion 113 with the underlayer 111, and the fixing colored portion 113 is adhered to the underlayer 111 with an adhesion force greater than the adhesion force of the first fixing colored portion 113a of the fixing colored portion 113 with the pattern layer 112.

In FIG. 14A, after one piece of the easy tear stickers 11 is attached onto a surface of a sealed object 2, the user may apply a force to an end of the underlayer 111 to lift the underlayer 111, and may selectively hold the extension 111E of the underlayer 111 to lift the underlayer 111 in order to complete the tearing process of the easy tear sticker 11. During the tearing process, the adhesive layer 115 is adhered to the fixing colored portion 113 with an adhesion force of greater than the adhesion force of the fixing colored portion 113 with the pattern layer 112, and the adhesive layer 115 is adhered to the fixing colored portion 113 with an adhesion force smaller than the adhesion force of the fixing colored portion 113 with the underlayer 111, so that after the easy tear sticker 11 is torn, an unresolved gap 114 will be formed between the first fixing colored portion 113a of the fixing colored portion 113 and the pattern layer 112. It is noteworthy that the adhesive layer 115 is adhered to the fixing colored portion 113 with an adhesion force smaller than the adhesion force of the fixing colored portion 113 with the underlayer 111, and the fixing colored portion 113 is adhered to the underlayer 111 with an adhesion force greater than the adhesion force of the fixing colored portion 113 with the pattern layer 112, so that after the easy tear sticker 11 is torn, the adhesive layer 115 will not remain on the sealed object 2.

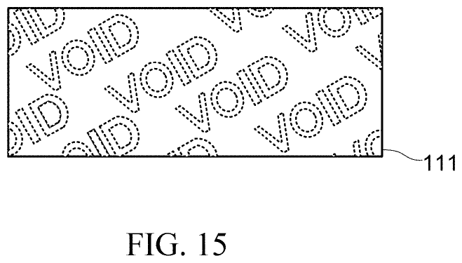

With reference to FIG. 15 for a bottom view of an underlayer of the easy tear sticker, after the easy tear sticker 11 is torn off, the adhesive layer 115 will not remain on the sealed object 2. Therefore, it is not necessary to clean up the sealed object 2. In addition, the easy tear sticker 11 can be reused and attached back onto the sealed object 2 again and used as an adhesive tape as shown in FIG. 15, but it keeps an appearance of being torn open. In FIG. 14B, the first pattern 118 of the pattern layer 112 is shown by the void 114, so that the bottom view of the underlayer 111 as depicted in FIG. 15 has the word “Void” or “Already Opened” to provide the confidential effect.

While the present disclosure has been described by means of specific embodiments, numerous modifications and variations could be made thereto by those skilled in the art without departing from the scope and spirit of this disclosure set forth in the claims.

What is claimed is:

1. An easy tear sticker assembly with a pattern layer, comprising:
a base, having a setting surface; and
a plurality of easy tear sticker units, disposed on the setting surface of the base, and having a spacing between any two adjacent easy tear sticker units; wherein each of the easy tear sticker unit comprises a plurality of easy tear stickers stacked on top of the other, and each of the easy tear stickers comprises:
an underlayer;
a pattern layer, covering an inner surface of the underlayer, and having a first pattern and a pattern gap; wherein the first pattern is formed on the inner surface of the underlayer;
a fixing colored portion, covering the pattern layer, and comprising a first fixing colored portion covering the first pattern and a second fixing colored portion filled into the pattern gap; and
an adhesive layer, covering the fixing colored portion.

2. The easy tear sticker assembly with a pattern layer as claimed in claim 1, wherein the base is a cylindrical base a slice-shaped base.

3. The easy tear sticker assembly with a pattern layer as claimed in claim 1, wherein the underlayer has at least one extension, such that the length of the underlayer is greater than the length of the pattern layer, the fixing colored portion, and the adhesive layer.

4. The easy tear sticker assembly with a pattern layer as claimed in claim 1, wherein the first pattern is one selected from the group consisting of a text, a letter, a number, a symbol, a figure, and a combination thereof.

5. The easy tear sticker assembly with a pattern layer as claimed in claim 4, wherein the pattern layer is adhered to the first fixing colored portion of the fixing colored portion with an adhesion force smaller than the adhesion force of the underlayer with the pattern layer, and the pattern layer is adhered to the first fixing colored portion of the fixing colored portion with an adhesion force smaller than the adhesion force of the adhesive layer with the first fixing colored portion of the fixing colored portion, and the underlayer is adhered to the second fixing colored portion of the fixing colored portion with an adhesion force greater than the adhesion force of the adhesive layer with the second fixing colored portion of the fixing colored portion.

6. The easy tear sticker assembly with a pattern layer as claimed in claim 5, wherein when the easy tear sticker is attached onto a surface of a sealed object and a force is applied to an end of the underlayer to lift the underlayer, then the whole adhesive layer will remain at the surface of the sealed object, and the whole first fixing colored portion covering the first pattern will stick onto the adhesive layer, and the pattern layer and the second fixing colored portion in the pattern gap will be separated together with the underlayer from the surface of the sealed object.

7. The easy tear sticker assembly with a pattern layer as claimed in claim 4, wherein the fixing colored portion is adhered to the underlayer with an adhesion force greater than the adhesion force of the fixing colored portion with the pattern layer, and the adhesive layer is adhered to the fixing colored portion with an adhesion force greater than the adhesion force of the fixing colored portion with the pattern layer of the first fixing colored portion.

8. The easy tear sticker assembly with a pattern layer as claimed in claim 7, wherein when the easy tear sticker is attached onto a surface of a sealed object and a force is applied to an end of the underlayer to lift the underlayer, the adhesion of the adhesive layer with the sealed object will act on the fixing colored portion, so that the fixing colored portion produces an action force to separate the pattern layer and the underlayer, and a void is formed between the first fixing colored portion of the fixing colored portion and the pattern layer by pulling.

9. The easy tear sticker assembly with a pattern layer as claimed in claim 4, wherein the adhesive layer is adhered to the fixing colored portion with an adhesion force greater than the adhesion force of the fixing colored portion of the first fixing colored portion with the pattern layer, and the adhesive layer is adhered to the fixing colored portion with an adhesion force smaller than the adhesion force of the fixing colored portion with the underlayer, and the fixing colored portion is adhered to the underlayer with an adhesion force greater than the adhesion force of the first fixing colored portion of the fixing colored portion with the pattern layer.

10. The easy tear sticker assembly with a pattern layer as claimed in claim 9, wherein when the easy tear sticker is attached onto a surface of a sealed object and a force is applied to an end of the underlayer to lift the underlayer, a gap is produced between the first fixing colored portion of the fixing colored portion and the pattern layer, and the adhesive layer will not remain on the sealed object.
